(19) United States
(12) Patent Application Publication
(10) Pub. No.: US 2023/0383147 A1
(43) Pub. Date: Nov. 30, 2023

(54) ANTI-TELESCOPING BUILDING ENVELOPE MATERIAL

(71) Applicant: SHURTAPE TECHNOLOGIES, INC., Hickory, NC (US)

(72) Inventors: Khaled EL-TAHLAWY, Hickory, NC (US); AMEET KULKARNI, Hickory, NC (US)

(21) Appl. No.: 18/031,680

(22) PCT Filed: Oct. 13, 2021
(86) PCT No.: PCT/US2021/054696

§ 371 Date: Apr. 13, 2023

Related U.S. Application Data
(60) Provisional application No. 63/091,109, filed on Oct. 13, 2020.
(60) Provisional application No. 63/091,073, filed on Oct. 13, 2020.

(51) Int. Cl. C09J 7/40; E04B 1/62; E04D 12/00

(52) U.S. Cl. CPC C09J 7/403; E04B 1/625; E04D 12/002; C09J 2301/302; C09J 2203/346

(57) ABSTRACT

A building envelope material is comprised of multiple layers, the layers include a substrate facestock, an adhesive layer, and a liner, the liner does not cover the entire surface of the adhesive in efforts to eliminate telescoping when the building envelope material is in a roll form. The removed portion of the liner may include straight coating removals or pattern coating removals.

This application claims the benefits of U.S. Provisional Application No. 63/091,073 filed Oct. 13, 2020 and U.S. Provisional Application No. 63/091,109 filed Oct. 13, 2020, the disclosures of which are herein incorporated by reference.

### BACKGROUND

The present disclosure relates to easy to apply air and water barrier articles and rolls thereof. The present disclosure also is related to a self-adhering air and water barrier article. It finds application as a roof underlayment and will be described via an exemplary embodiment thereof. Further, it finds applications as a house wrap and will be described via an exemplary embodiment thereof. However, it is to be appreciated that the exemplary embodiments are also amenable to other applications.

Modern building structures often make use of barrier membrane sheet materials to control the flow of moisture in and out of a building and also to control the ventilation or movement of air through a wall or roof structure. Typical membrane products are designed to be weather resistant, keeping out liquid water and resisting wind pressure.

At the same time however, some membranes may be formed so that water vapor may pass through relatively freely to avoid problems of dampness or condensation within a building or within a wall or roof structure. A number of water vapor permeable membrane products are available and combine weather resistance with water vapor permeability.

An underlayment material is commonly used in roofing applications as well as other underlayment situations. The typical product utilized in roofing underlayment is commonly referred to as “tar” of “felt” paper. The traditional “tar paper” is an asphalt impregnated paper product which is sold in a roll; unrolled on a roof; cut to length; and fastened to the roof utilizing staples or nails. Although tar paper is inexpensive, it does not seal nail holes through the paper and thus does not prevent water infiltration. In addition, once the felt is rolled out, it absorbs water and once wet, it wrinkles and expands, and must be allowed to dry out before covering with shingles. Other prior art shingle underlayment products also suffer from the same problems.

Accordingly, what is needed are generally low cost, heavyweight or lightweight, dimensionally stable underlayment products on which the installer can walk, without sticking or slipping, which will not slide underfoot and which will cold flow and/or elongate and recover to seal nail holes and other punctures. The product should be easy to apply without sticking to itself during application. In addition, such products should be dimensionally stable, resist tearing, non-adhesive to other layers, and provide hot and cold flexibility.

Moreover, moisture may permeate from gaps of such fasteners, such as nail holes, over a long period of time. Previously known waterproofing sheets having both waterproofing and moisture permeability have been developed. One example of such moisture-permeable waterproofing sheets is flash-spun nonwoven fabrics. U.S. Pat. No. 3,169,899, for example, discloses a flash-spun nonwoven fabric. U.S. Pat. No. 3,532,589 discloses a method for producing a flash-spun nonwoven fabric. The nonwoven fabric blocks water but allows water vapor to pass therethrough. A known example of the nonwoven fabric is commercially available under the trade designation “Tyvek” from E. I. Du Pont de Nemours and Company, Wilmington, Del. USA. It is beneficial for such moisture-vapor permeable waterproofing sheets to pass ASTM D-1970/D-1970M-13 or similar modified tests such as Modified Test 1 of ASTM D-1970/D-1970M-13, Modified Test 2 of ASTM D-1970/D-1970M-13, or Modified Test 3 of ASTM D-1970/D-1970M-13 for nail seal ability.

Accordingly, a desirable roof underlayment and a desirable house wrapping can be a multi-layer structure providing at least nail seal ability and optionally antiskid, UV resistance, and fire resistance.

One shortcoming of existing roof underlayment designs and existing house wrapping designs, referred collectively as building envelope materials, is their propensity to telescope during application. Moreover, building envelope materials are typically applied in a rolled form which is unrolled on the roof, wall, or other surface and adhesively secured thereto. Such rolls can be several feet wide and tens of feet in length. This rolled form can experience telescoping during handling wherein the coiled layers on the interior of the roll slide outwardly from the edge of the outer coiled layers, particularly when the roll is being attached to a sloped roof, vertical wall, or other surface. The present invention provides a solution to the telescoping problem

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

According to a first embodiment, an anti-telescoping building envelope material is provided. The barrier includes multiple layers including a substrate facestock, an adhesive layer overlying to the substrate facestock, and a liner overlying the adhesive. The liner does not cover an entire surface of the adhesive layer.

The building envelope material can be in the form of a roll.

The substrate feedstock can be multi-layer.

In certain embodiments, the liner can further function as a transfer substrate.

The liner does not cover between about 0.3 and 10 percent of the adhesive layer. The liner may be an uninterrupted layer or a patterned layer.

In some embodiments, the liner exposes one or both edge(s) of the adhesive layer. In other embodiments, the liner exposes the middle of the adhesive layer. In yet other embodiments, the liner exposes one edge of the adhesive layer and the middle of the adhesive layer.

In alternative embodiments, the liner contains a plurality of passages that expose the adhesive. In some embodiments, the passages are selected from circular, diamond-shaped, or rectangular-shaped holes near the edge of the building envelope material that expose the adhesive. In other embodiments, the passages have holes that are all the same shape. In yet other embodiments, the liner contains several selectively removed geometric-shaped holes near the edge of the building envelope materials that expose the adhesive.

A method of making an anti-telescoping building envelope material includes providing a multi-layer substrate facestock, joining an adhesive attached to the substrate facestock, and attaching a liner that does not cover the entire surface of the building envelope material to the adhesive.

A method of installing an anti-telescoping building envelope material includes attaching the liner with exposed adhesive, removing an additional amount of liner, and securing the adhesive to the roof, wall, or other surface.

The method of installing the barrier may further include removing an additional amount of liner in sections.

A primary advantage of the building envelope material is that it is anti-telescoping and does not adhere to itself during the application process. the selectively removed liner portions allow the building envelope material to stick to itself minimally while in a roll to prevent uneven application.

This invention is ideally suitable for building construction. It is generally light weight and can be disposed on building a roof or home.

Another advantage of the building envelope material is that the building envelope material is water impermeable and vapor permeable. This is to allow vapors to exit the home, but outside forces such as rain cannot disturb the inside of the home.

Still other benefits and advantages of the present disclosure will become more apparent from reading and understanding the following detailed description.

### BRIEF DESCRIPTION OF THE DRAWINGS

FIG. 1 is a side cross-section view of a straight coating of the building envelope material.

FIG. 2A is a side cross-section view of an exemplary embodiment of the building envelope material where the liner is removed in two strips along the length of the building envelope material on both the left and right edges.

FIG. 2B is a bottom view of the embodiment of FIG. 2A.

FIG. 3A is a side cross-section view of an exemplary embodiment of the building envelope material where the liner is removed in one strip along the length of the building envelope material on the left edge.

FIG. 3B is a bottom view of the embodiment of FIG. 3A.

FIG. 4A is a side cross-section view of an exemplary embodiment of the building envelope material where the liner is removed in one strip along the length of the building envelope material on the right edge.

FIG. 4B is a bottom view of the embodiment of FIG. 4A.

FIG. 5A is a side cross-section view of an exemplary embodiment of the building envelope material where the liner is removed in two strips along the length of the building envelope material on the right edge.

FIG. 5B is a bottom view of the embodiment of FIG. 5A.

FIG. 6A is a side cross-section view of an exemplary embodiment of the building envelope material where the liner is removed in two strips along the length of the building envelope material on the left edge.

FIG. 6B is a bottom view of the embodiment of FIG. 6A.

FIG. 7A is a side cross-section view of an exemplary embodiment of the building envelope material where the liner is removed in three strips along the length of the building envelope material on the left edge, right edge, and middle.

FIG. 7B is a bottom view of the embodiment of FIG. 7A.

FIG. 8A is a side cross-section view of an exemplary embodiment of the building envelope material where the liner is removed in one middle strip along the length of the building envelope material.

FIG. 8B is a bottom view of the embodiment of FIG. 8A.

FIG. 9 is a side cross-section view of a pattern coating of the building envelope material.

FIG. 10 is a bottom view of an exemplary embodiment of the building envelope material where circular holes are selectively removed in one strip along the length of the building envelope material on both the left and right edges.

FIG. 11 is a bottom view of an exemplary embodiment of the building envelope material where circular holes are selectively removed in one strip along the length of the building envelope material on the left edge.

FIG. 12 is a bottom view of an exemplary embodiment of the building envelope material where circular holes are selectively removed in one strip along the length of the building envelope material on the right edge.

FIG. 13 is a bottom view of an exemplary embodiment of the building envelope material where circular holes are selectively removed in two strips along the length of the building envelope material on the right edge.

FIG. 14 is a bottom view of an exemplary embodiment of the building envelope material where circular holes are selectively removed in two strips along the length of the building envelope material on the left edge.

FIG. 15 is a bottom view of an exemplary embodiment of the building envelope material where circular holes are selectively removed in three strips along the length of the building envelope material on the left edge, right edge, and middle.

FIG. 16 is a bottom view of an exemplary embodiment of the building envelope material where circular holes are selectively removed in one middle strip along the length of the building envelope material.

FIG. 17 is a bottom view of an exemplary embodiment of the building envelope material where diamond-shaped holes are selectively removed in one strip along the length of the building envelope material on both the left and right edges.

FIG. 18 is a bottom view of an exemplary embodiment of the building envelope material where rectangular-shaped holes are selectively removed in one strip along the length of the building envelope material on both the left and right edges.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used herein, the terms about, generally and substantially are intended to encompass structural or numerical modifications which do not significantly affect the purpose of the element or number modified by such term.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “building envelope material” and “barrier” refers individually and collectively to roof underlayment, underlayment, house wrapping, and wrapping.

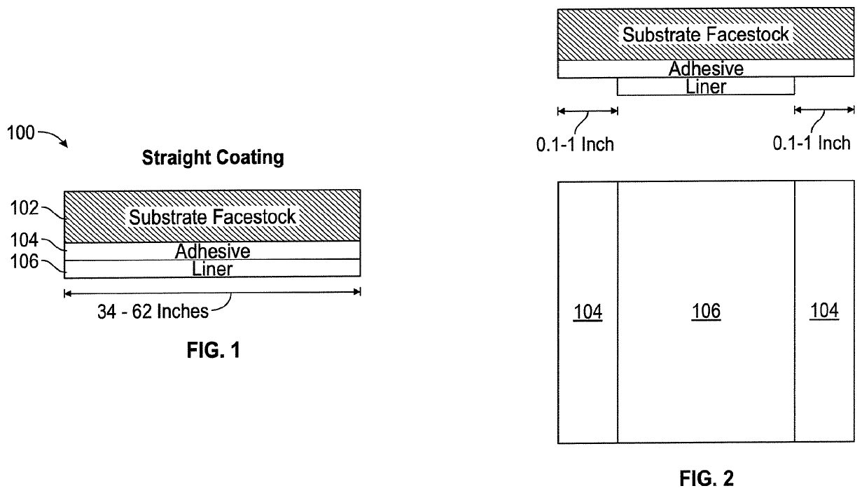

Referring now to FIG. 1, the building envelope material includes a substrate facestock 102, an adhesive 104, and a liner 106. the width of the building envelope material 100 varies between 34 and 62 inches. the building envelope material may be in the form of a roll.

In one or more embodiments, the substrate facestock 102 may include multiple layers. The substrate facestock 102 can be a water repellant surface that is comprised, for example, of a styrene acrylic base polymer with a hydrophobic acrylate with optional filler or pigment. This enables water repellency combined with UV resistance and slip resistance. The building envelope material can be water impermeable but vapor permeable. this is to allow vapors to exit the home, but outside forces such as rain cannot disturb the inside of the home. A water vapor permeable sheet may be microporous, microperforated or some other type of vapor permeable sheet or film. A microporous sheet can be a non-perforated continuous microfibre web with microscopic pores large enough for moisture vapor to pass through, but small enough to resist air and liquid water. Microperforated membranes depend on mechanical pin-perforations and/or film laminations to build in properties. An exemplary barrier is described in U.S. Provisional Application No. 62/942,460, filed Dec. 2, 2019, the disclosure of which is herein incorporated by reference.

Suitable microporous sheets can be spun bonded or fibrous bonded polyolefin as described in U.S. Pat. Nos. 3,532,589 and 5,972,147, the disclosures of which are herein incorporated by reference. Exemplary polyolefins are polyethylene and polypropylene. One commercially available microporous sheet is sold under the trademark Tyvek. Other suitable microporous sheets include oriented polymeric films as described in U.S. Pat. No. 5,317,035, herein incorporated by reference, which comprise ethylene-propylene block copolymers. One exemplary film is commercially available from RKW Group under the trademark Aptra.

The sheets may be reinforced with various types of scrim materials or may be laminated to other sheets or films, such as non-woven polypropylene or non-woven polyester for the purpose of improving strength and other physical properties. Suitable sheet material could be multi-layer laminates including a microporous or microperforated layer (e.g. polytheylene). An example of such a sheet material is Utraperm Lite or Ultraperm Max supplied by Industrial Textiles and Plastics, United Kingdom.

Typical water barrier membranes will be supplied in roll form and have a width (cross-direction or XD) in the range of about 30 to 250 cm, more typically about 60 to 160 cm; and a length (machine direction or MD) of about 5 to 80 m, more typically about 15 to 40 m. In general, the membrane will typically have a thickness of 0.001 to 0.008 or 0.001 to 0.025 inches.

A UV curable acrylic pressure sensitive adhesive 104 can be employed. Any pressure sensitive adhesive used to adhere air and water barrier articles to roofs, walls, or other surfaces may be used. These include vapor impermeable pressure sensitive adhesives. An example of the latter is a rubber modified asphalt (bitumen) pressure sensitive adhesive or a synthetic rubber pressure sensitive adhesive. Such pressure sensitive adhesives are well known in the art. The adhesive layer 104 can be permeable to vapors but water-impermeable. An exemplary adhesive is described in U.S. Provisional Application No. 62/907,894, filed Sep. 30, 2019, the disclosure of which is herein incorporated by reference.

Additionally, a liner 106 can be provided to protect the adhesive layer 104. An exemplary liner material is formed of paper or polymer. Particularly suitable materials include, but are not limited to, release coated kraft paper, PET, or PP. In certain embodiments, the liner will also serve as a substrate upon which the adhesive is cured before application to the facestock.

The liner 106 does not cover an entire surface of the adhesive layer 104. In at least manufacturing processes where the liner is a transfer substrate for the adhesive during cure, the liner is removed to expose a limited surface area of the adhesive. In this manner, when the building envelope material is rolled, a portion of the exposed adhesive will come in contact with the facestock substrate with which it has an affinity for attachment. By providing a limited surface area of exposed adhesive, the rolled underlayment can still be unrolled for application to a roof, wall, or other surface foundation but can have resistance to telescoping.

The liner 106 may not cover between about 0.3 and 10 percent of the adhesive layer 104. The liner 106 may be in a straight coating 100 or in a pattern coating 200.

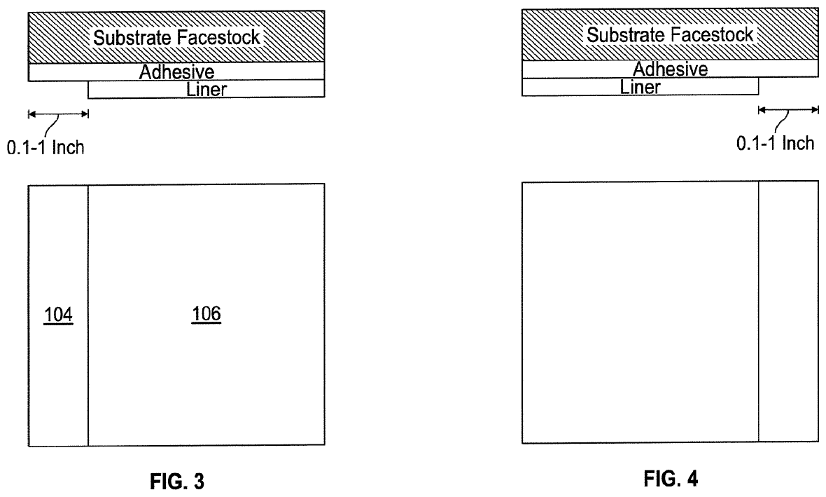

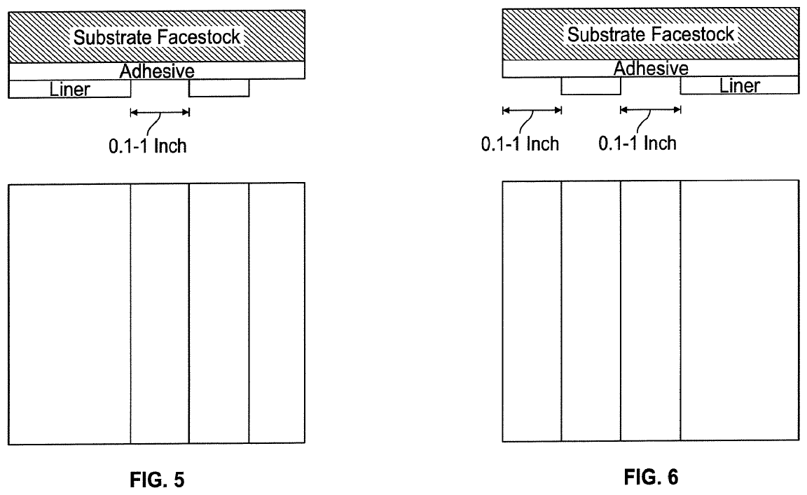

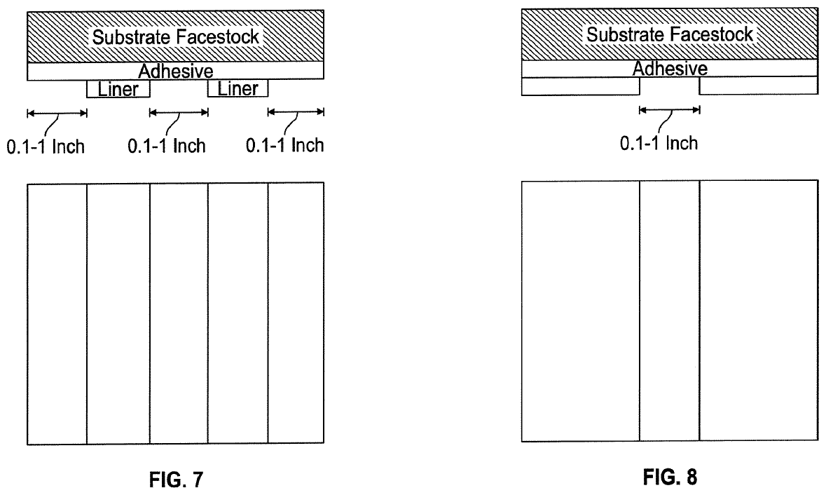

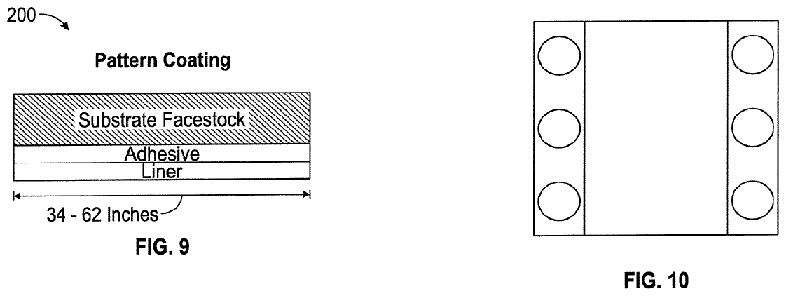

In some embodiments, such as FIG. 2, the liner 106 is removed on each edge of the adhesive layer 104. In other embodiments, the liner 106 is removed on one edge of the adhesive layer. In FIG. 3 the liner 106 is removed and exposes the adhesive layer 104 on the left edge while in FIG. 4, the liner 106 is removed and exposes the adhesive layer 104 on the right edge. In yet other embodiments, such as FIG. 5 and FIG. 6, the liner 106 is removed on one edge of the adhesive layer 104 and in the middle of the adhesive layer 104. In alternative embodiments, such as FIG. 7, the liner 106 can be removed from both edges and the middle of the adhesive layer 104. In yet alternative embodiments, such as FIG. 8, the portion of the liner 106 removed can be inside and near the middle of the adhesive layer 104.

In each of the embodiments where the liner 106 exposes the adhesive 104 in a strip, the adhesive may be exposed from 0.1 to 1 inches.

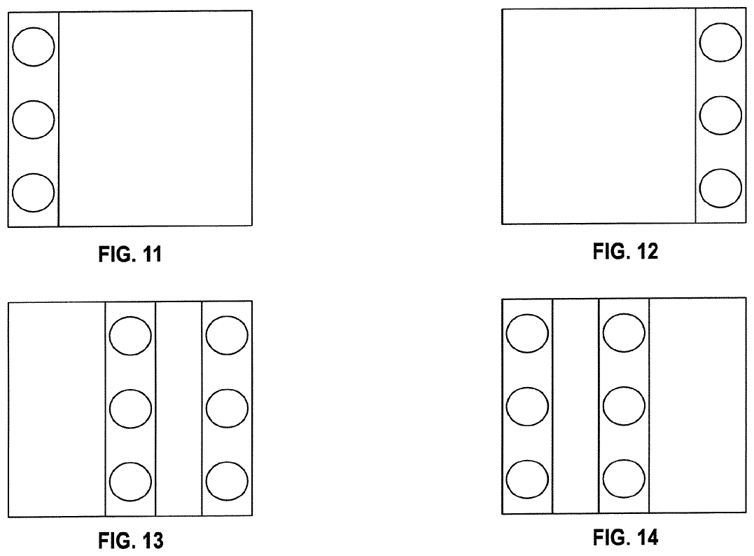

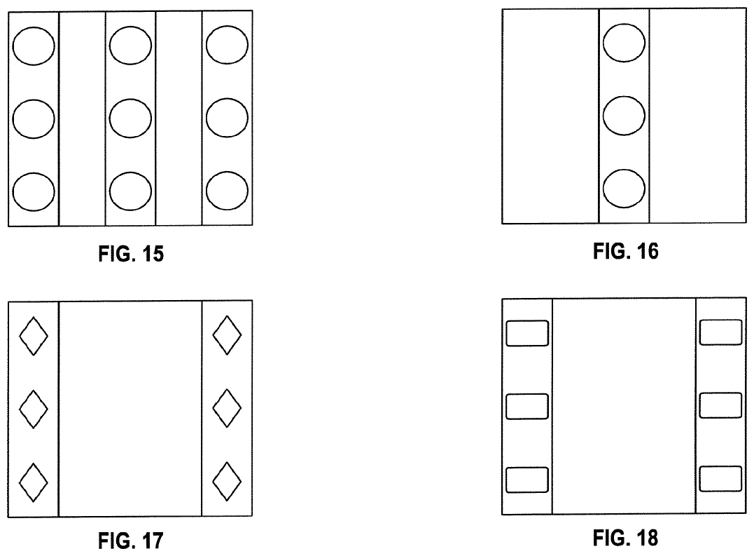

In alternative embodiments, the liner contains a plurality of passages that expose the adhesive. In some embodiments, such as FIG. 10-18, the passages are selected from circular, diamond-shaped, or rectangular-shaped holes near the edge of the building envelope material that expose the adhesive. in other embodiments, the passages have holes that are all the same shape. in yet other embodiments, the liner 106 contains several selectively removed geometric-shaped holes near the edge of the building envelope material that expose the adhesive.

It is generally contemplated that the use of substantially linear removal of liner strips (edge(s) and/or middle) may be used when the liner 106 is a transfer substrate for adhesive curing. Moreover, in that embodiment, the liner 106 will be a continuous surface and will be at least as long/wide as the adhesive layer 104. Therefore, removal of the liner 106 to expose adhesive may be most easily achieved by linear slitting and removal.

However, if the adhesive is directly applied to the facestock substrate 102 or the adhesive transfer substrate is removed after the adhesive 104 is cured and applied to the facestock substrate 102, the use of the patterned liner may be desirable. Moreover, in that embodiment, the liner 106 can be patterned prior to attachment to the wall, roof, or other surface.

In alternative embodiments, the liner 106 can be removed along the length of the adhesive layer 104 with a 0.4 to 3 foot-long pattern strip of the liner 106 remaining with the full width adjacent to an edge of the building envelope material. this configuration allows a roll of the building envelope material to be formed with the liner as an exterior surface. Moreover, the exposed adhesive on the interior coils of the roll will provide anti-telescoping properties, where the full liner coverage at the end of the underlayment sheet results in no adhesive exposure on the exterior surface of the roll. In this context, based on the dimension of the roll, the present embodiment may also be expressed as a sufficient length of full width liner coverage over a length sufficient to cover the outermost surface of the rolled product. An advantage to this configuration is that it may make installation easier as the natural movement of unrolling and installing is easier with the adhesive exposed.

In a further alternative embodiment, it is envisioned that the building envelope material is self-winding. More particularly, the material is self-winding because a release liner is not required as the adhesive layer directly contacts the substrate in a rolled form. In this regard, the surface of the substrate material that contacts the adhesive when rolled up can be treated or constructed in a manner such that the adhesive does not strongly adhere thereto. To make such an embodiment consistent with the rest of the present disclosure, it is envisioned that the substrate includes untreated regions consistent with the liner removal embodiments described above. In short, small regions of the substrate are untreated to create relatively strong bonding of the adhesive to the substrate and provide the anti-telescoping property.

In a related embodiment, a method of making an anti-telescoping building envelope material is provided. the method includes providing a multi-layer substrate facestock, joining an adhesive and overlying liner that does not cover the entire surface of the adhesive to the building envelope material.

In a similarly related embodiment, a method of installing an anti-telescoping building envelope material is provided. the method includes attaching the liner to the roof with the exposed adhesive, removing an additional amount of liner, and securing the newly exposed adhesive to the roof, wall, or other surface. The method of installing the barrier may further include removing an additional amount of liner in sections. A benefit to this method of installation is that the barrier, when in a roll, will not telescope when being laid since the minor portions of adhesive will cause the underlayment to stick to itself.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof. To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

1. An anti-telescoping building envelope material comprising:
a substrate facestock;
an adhesive layer overlying the substrate facestock; and
a liner overlying the adhesive, wherein the liner does not cover an entire surface of the adhesive layer.

2. The building envelope material of claim 1 wherein the underlayment is in the form of a roll.

3. The building envelope material of claim 1 wherein the substrate facestock is multi-layer.

4. The building envelope material of claim 1 wherein the liner further functions as a transfer substrate.

5. The building envelope material of claim 1 wherein the liner does not cover between about 0.3 and 10 percent of the adhesive layer.

6. The building envelope material of claim 1 wherein the liner exposes one edge of the adhesive layer.

7. The building envelope material of claim 1 wherein the liner exposes each edge of the adhesive layer.

8. The building envelope material of claim 1 wherein the liner exposes a middle of the adhesive layer.

9. The building envelope material of claim 1 wherein the liner exposes at least one edge of the adhesive layer and a middle of the adhesive layer.

10. The building envelope material of claim 2 wherein the liner is not removed over about 0.4 to 3 feet adjacent an end of the barrier roll.

11. The building envelope material of claim 1 wherein the liner is a discontinuous pattern.

12. The building envelope material of claim 1 or 10 wherein the liner includes a plurality of passages that expose the adhesive.

13. The building envelope material of claim 11 wherein the passages comprise repeating geometric-shaped openings adjacent at least an edge of the adhesive layer.

14. The building envelope material of claim 11 wherein the passages are selected from circular, diamond-shaped, or rectangular-shaped or a combination thereof.

15. The building envelope material of claim 13 wherein the passages are all the same shape.

16. The building envelope material of claim 1 wherein the substrate facestock is microporous, microperformed or an otherwise vapor permeable sheet or film.

17. (canceled)

18. A method of making an anti-telescoping building envelope material comprising:
providing a multi-layer substrate facestock;
applying an adhesive to the substrate facestock; and
attaching a liner that does not cover the entire surface of the building envelope material to the adhesive.

19. (canceled)

20. (canceled)

21. A method of making an anti-telescoping building envelope material comprising:
providing a multi-layer substrate facestock;
applying an at least partially uncured adhesive to a transfer substrate;
applying the adhesive and transfer substrate to the substrate facestock; and
removing at least a portion of the transfer substrate, such that the remaining transfer substrate functions as a building envelope material liner with exposed areas of adhesive.

22. The method of claim 21 further comprising curing the adhesive on the transfer substrate.

23. A method of installing the anti-telescoping building envelope material of claim 1 comprising:
a) attaching the building envelope material to a roof using the exposed adhesive;
b) removing an amount of liner;
c) securing newly exposed adhesive to the roof; and
d) repeating steps b and c.
